(19) United States
(12) Patent Application Publication
(10) Pub. No.: US 2009/0139820 A1
(43) Pub. Date: Jun. 4, 2009

(54) Power transmission device and method of assembly of a damper configuration in a power transmission device

(75) Inventor: Thorsten Krause, Buehl (DE)

Correspondence Address: Davidson, Davidson & Kappel, LLC, 485 7th Avenue, 14th Floor, New York, NY, 10018, US

(73) Assignee: LUK LAMELLEN UND KUPPLUNGSBAU BETEILIGUNGS KG, Buehl (DE)

(21) Appl. No.: 12/313,408

(22) Filed: Nov. 20, 2008

(30) Foreign Application Priority Data
Nov. 22, 2007 (DE) 10 2007 056 368.1

(51) Int. Cl. F16H 41/00; B25B 27/14

(52) U.S. Cl. 192/3.29; 29/281.5

(57) ABSTRACT

A power transmission device for configuration in a drive train between a prime mover and a power take-off with a hub element forming an output and a damper configuration connected upstream of the output, including at least two dampers disposed in radial direction offset relative to one another and coupled with one another—a first damper forming a main damper stage and a second internal damper—wherein the second internal damper is coupled with the hub.

The dampers forming individual damper stages can be preassembled respectively as a unit and are connected with one another via a coupling.

This claims the benefit of German Patent Application No. 10 2007 056 368.1 filed on Nov. 22, 2007, and hereby incorporated by reference herein.

### BACKGROUND

The invention relates to a power transmission device interposed in a drive train between a prime mover and a power take-off with a hub element coupled with an output or constituting an output and a damper configuration connected upstream of the output. Said damper comprising at least two dampers in radial direction disposed, offset relative to one another and coupled with one another—a first damper forming a main damper stage and a second internal damper—wherein the second internal damper is coupled with the hub.

Power transmission devices, particularly in three-channel design, for application in drive trains between a prime mover and a power take-off, particularly of a transmission unit are known in a large number of embodiments as a combined starting and power transmission unit. These generally comprise a hydrodynamic component in the form of a hydrodynamic clutch or a hydrodynamic speed/torque converter, a device at least bypassing the power transmission via the hydrodynamic component as well as an apparatus for damping vibrations. On the one hand, a first power branch through the power flow via the hydrodynamic component can be described; a second power branch is through the power flow via a device for bypassing the power transmission via the hydrodynamic component that is generally formed as a switchable clutch device. Preferably, the apparatus for damping vibrations in the form of the torsional vibration damper in the power flow from input to output of a power transmission device is respectively disposed downstream of both the hydrodynamic component as well as the switchable clutch, so that vibration damping takes place in each operating state. The apparatus for damping vibrations acts at the same time as an elastic clutch, that is, it transmits torque and simultaneously compensates rotational irregularities. The apparatus must therefore be designed for the maximum torque to be transmitted. In the embodiment of the power transmission apparatus, in three-channel design, it is not the pressure already present in the inner chamber that is used for bridging, but rather, the pressure is purposefully provided in the desired magnitude. For this purpose the switchable clutch is provided with an actuator that comprises a piston element activated via a chamber pressurized with appropriate fluid that acts on individual elements of the clutch device in such a manner that they are brought into mutual interaction, in the simplest case, by means of frictional contact. The damping effect generated in torsional vibration dampers disposed downstream is at the same time dependent on its design, wherein this is essentially determined by the design of the means of spring and/or damping coupling. To be able to have focused influence on individual operation areas, the apparatus for damping vibrations is generally designed as a damper configuration that comprises a predamper stage for small angular deflection and a main damper stage for larger angular deflection range. In particular, in embodiments in the three-channel design with both the hydrodynamic components and switchable clutch for power transmission from input to output, in the apparatus for damping vibrations downstream of power flow, this is spatially disposed between the two components. As such, the assembly is relatively complex, or rather, certain fixation types, particularly in the form of riveted connections, are not possible since no space is available for an appropriate riveting tool. Another problem is that, in certain proportions, the connection between the hydrodynamic component—particularly the turbine wheel and the apparatus for damping vibrations—is not possible by means of a rivet joint because space is not available for this purpose. Furthermore, other solutions would generally lead to the situation in which substantial assembly scope or too severe limitation must be accepted for possible torsional-damping characteristics, particularly with regard to the arrangement radius and thus radial extension of predamper and main damper stages.

### SUMMARY OF THE INVENTION

An object of the invention is to provide an improved power transmission device of the type mentioned above, in that, the device may be equipped with a damper configuration that at least comprises includes a damper forming a main damper stage and a second damper forming a predamper stage, which are disposed, offset relative to one another in radial direction and which are designed freely and easily assembled with regard to their characteristic curves.

A power transmission device in a drive train interposed between a prime mover and a power take-off, with a hub element forming the output and comprises a damper configuration connected upstream of the output. At least two dampers disposed, offset relative to one another in radial direction and coupled with one another, a first external damper forming a main damper stage and a second internal damper forming a predamper stage, wherein the internal damper is coupled with hub. Wherein the damper forming individual damper stages are designed and formed respectively in order to be preassembled as a unit and be connectable with one another via means for coupling at least in circumferential direction, preferably also in radial direction, wherein the second internal damper can be pushed into the external damper.

According to the invention, it is possible to manufacture individual dampers from the beginning onwards as an assembly unit, particularly to rivet individual damper parts independently of one another. Actual coupling occurs at the input of the means of connection between individual dampers. The invention therefore may facilitate], particularly, the use of available space optimally for the predamper stage, thus, the space in radial direction, between a device for bridging and the hydrodynamic component, wherein the dampers forming individual damper stages are assembled consecutively and as such may not hinder themselves during the assembly.

In accordance with a particularly advantageous embodiment, the second internal damper stage may already be splined with the hub element prior to insertion and integrated as a preassembled unit in the power transmission device.

The means of connection can be designed in different ways. In accordance with a first embodiment, these may include form-closed connection means. Already through the geometrical design, these allow coupling in radial direction. This coupling or rather connection means can be aligned either directly in radial direction or in axial direction. What is decisive is that power flow can be directed in radial direction. These means can be executed in the simplest case as a plug-in connection. The plug-in connection can be realized in various and different ways. In the simplest case, one of the elements to be coupled with one another comprises projections and recesses that engage with one another. The form-closed connection is further characterized in that this is generally easily detachable and does not require additional locking measures.

In accordance with a further embodiment, the means can be formed in a non-form-closed manner. However, this is generally more complex.

To avoid undesired noise development or vibration excitation as well, in the means of coupling, they can be equipped with means of damping coupling.

The configuration between the damper forming the predamper stage and the damper forming the main damper stage is preferably particularly advantageous in version, thus in an axial plane, in that both dampers are quasi disposed inside one another. This may be done by a particularly space-saving configuration, wherein, owing to the preassembled embodiment of the second internal damper, no consideration must be taken towards the possibilities of assembling the first damper and particularly the linkage of connection elements to the first damper.

In accordance with a further alternative embodiment, the damper forming the predamper stage and the damper forming the main damper stage can be disposed, offset relative to one another also in the axial direction. This is particularly then the case, when the space should be used optimally, both in axial and radial directions and at the same time, if possible, when the resulting free configuration spaces can be used by other elements in the power transmission device.

Each individual damper can be formed as individual damper or can also comprise series-connected or parallel-connected damper subunits and be joined together. This may not play any role for the coupling between the two dampers of the damper configuration. Because, in this case, only the one part, particularly the damper forming the input or output part of the main damper stage may be connected in a rotationally rigid manner with an input part of the element forming the predamper stage via the means for coupling the two dampers with one another.

Regarding the formation of damper configuration itself, it can be formed basically as series-connected or parallel-connected dampers. This is essentially dependent on the coupling of the two dampers with one another. The formation as series-connected or parallel-connected dampers may be selected in accordance with the application requirements on the desired characteristic curve.

In a particularly advantageous further embodiment, a deflection angle limit may be integrated in the means of connection of the two dampers of the configuration for the damper forming the predamper stage. This solution is characterized by a particularly high function concentration, in that the deflection angle limit may be transferred to the connection plane.

The individual damper or combination of damper subunits as considered by a primary part acting as an input part, and a secondary part acting as an output part in power flow direction from input to output of the power transmission device, wherein individual damper subunits again respectively have input and output parts when viewed in power flow direction, wherein at least a partial element of a subordinate damper is identical with the input part of the damper configuration, and furthermore a further element is identical with the output part of the first external damper. This applies analogously also to the dampers forming the predamper stage. This also may include a primary part and a secondary part. Concerning clutch possibilities, there may be different possibilities depending on the embodiment of the entire damper configuration. In accordance with a first embodiment the primary part of the second series-connected damper may be coupled via the means of coupling with the secondary part and thus with the output part of the first damper that forms predamper stage. The second variant comprises may include coupling input parts of the two dampers in a rotationally rigid manner with one another and output parts as well, wherein in this case the output part of the entire damper configuration may be formed by the output parts of both dampers.

Primary parts and secondary parts of individual damper configurations can be formed as clutch discs, wherein these can be formed, for instance, as axial side discs or as a middle flange. The primary parts can at the same time consist of two side discs coupled together in a rotationally rigid manner and the secondary part can consist of a flange interposed in-between or vice versa.

The maximum extension of predamper stage in radial direction may lie at the same time in the area of a small internal diameter of the device for bridging the hydrodynamic power transmission. In this manner, it may be ensured that an assembly in the power transmission unit is possible through axial insertion even after an installed first external damper stage.

A method of assembly of a power transmission device is characterized in that individual dampers or damper configurations are preassembled as separate units and respectively separately integrated independently of one another in the power transmission device, wherein first the outer damper may be introduced and connected with the connection elements, particularly with the output part of a device for at least partially bridging the power transmission via the hydrodynamic component and furthermore with the output of hydrodynamic component, wherein coupling with hydrodynamic component can occur in an arbitrary radius. The coupling with the first or second clutch part may occur at the same time at a radius greater than internal circumference of a switchable clutch device.

A method of assembly of a damper configuration according to the invention may include at least two dampers coupled with one another and disposed in radial direction. The dampers are offset relative to one another and a first radially external damper forms a main damper stage and a second internal damper in a power transmission device is interposed in a drive train between a prime mover and a power take-off with an input coupled with an output or a hub element forming said output which is connected upstream of damper configuration, wherein the second internal damper is coupled with the hub element, wherein the dampers forming individual damper stages are respectively preassembled as unit and individually added consecutively in the power transmission device, wherein the first external damper is mounted and respectively connected with the connection elements and after successful connection of the second internal damper it is inserted in axial direction parallel to the rotation axis and the two dampers may be connected with one another via means of coupling at least in circumferential direction, preferably also in radial direction.

### BRIEF DESCRIPTION OF THE DRAWINGS

The solution according to the invention is explained in the following figures in detail. The figures in detail:

FIG. 1 shows a particularly advantageous embodiment of a damper configuration in an axial section and a power transmission device according to the invention;

FIG. 2 shows Section A-A in accordance with FIG. 1;

FIG. 3 shows schematically the coupling of the masses;

FIG. 4 shows a further embodiment in accordance with FIG. 1, in axial section.

### DETAILED DESCRIPTION

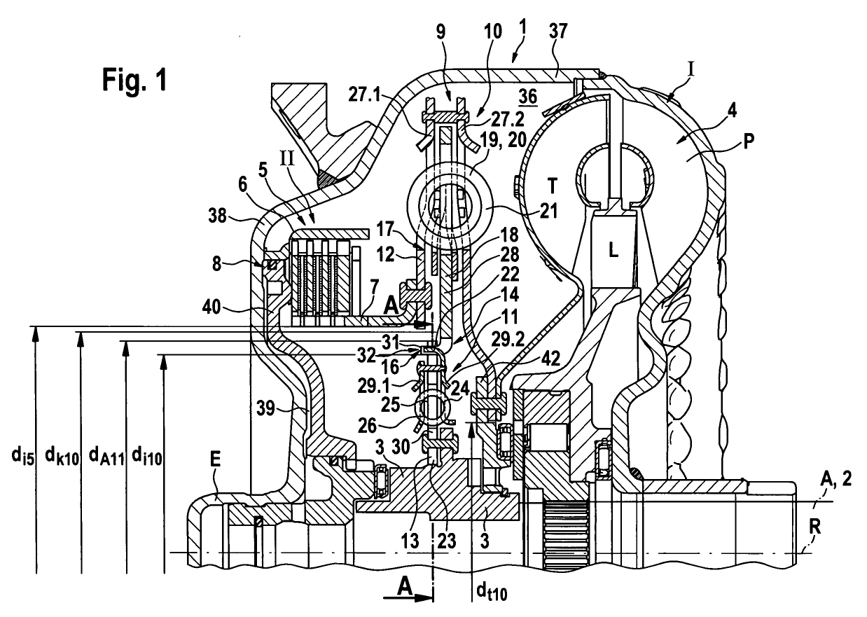

In schematically simplified axial-section illustration, FIG. 1 clarifies an embodied power transmission device 1 according to the invention. Said power transmission device 1 is formed as a combination of starting unit and power transmission unit, and comprises at least an input E and an output A. The input E can at the same time, at least indirectly, be coupled with a prime mover, whereas output A is connected with a power take-off, generally a transmission downstream of power transmission device 1, particularly it is connected to a transmission input shaft 2 and formed by this or by an element in a rotationally rigid manner, coupled with said shaft, here in form of a hub 3. A hydrodynamic component 4 is interposed between input E and output A. This comprises at least a primary wheel acting as impeller P for power transmission in power flow direction from input E to output A and a secondary wheel acting as turbine wheel for power transmission from input E to output A, wherein impeller P in this functional state is connected with input E in a rotationally rigid manner, either directly or via a housing cover 38 connected with impeller shell 37. The turbine wheel T is connected at least with output A, either directly or indirectly by means of further transmission elements. The hydrodynamic component 4 further comprises at least a stator L. The hydrodynamic component 4 in this case is formed as a hydrodynamic speed/torque converter, that is, speed conversion accompanies torque conversion. Embodiments without stators are likewise considerable. In this case a hydrodynamic clutch is involved, which only serves the purpose of speed conversion. The power flow via hydrodynamic component 4 at the same time describes a hydrodynamic power branch I. Furthermore, power transmission device 1 comprises a device 5 at least for partially bridging power transmission via hydrodynamic component 4. This device is also designated as bridging clutch and is formed as a switchable clutch. The embodiment of device 5 according to the present power transmission device 1 is in the form of a frictional clutch. This comprises at least a first clutch part 6, which is at least connected indirectly in a rotationally rigid manner with input E, preferably directly, and a second clutch part 7, which is at least indirectly coupled with output A. Furthermore, an actuator 8 is provided, through which the first clutch part 6 can be brought in active connection with the second clutch part 7 at least indirectly and thus enables power transmission. If device 5 is activated, in that actuator 8 is activated, power transmission occurs at least partially, preferably fully via device 5 to output A in a second power branch II. A damper configuration 9 is respectively connected downstream in the power flow from input E to output A in individual power branches I, II—hydrodynamically or mechanically. The power always flows simultaneously in both power branches I, II before output A via damper configuration 9. The damper configuration 9 comprises at least two dampers 10 and 11 disposed, offset in radial direction, relative to one another, a first external damper 10 and a second internal damper 11, wherein the first external damper 10 forms a main damper stage, whilst internal damper 11 acts as a predamper stage. Both are effective through different deflection angles. Furthermore, both dampers 10 and 11 are coupled with one another, wherein the second internal damper 11 is connected in a rotationally rigid manner with output A via hub 3. The two dampers 10 and 11 are disposed, offset relative to one another in radial direction. Preferably, configuration in axial direction occurs in axial plane area. In depicted case, damper configuration 9 is formed as a series-connected damper with an integrated predamper stage that is realized by means of second damper 11. The damper configuration 9 at the same time comprises an input 12 and an output 13, wherein input 12 respectively with hydrodynamic component 4, particularly viewed in power flow direction is connected in a rotationally rigid manner with output in hydrodynamic power branch, in form of the turbine wheel T at least indirectly and furthermore with the output of the device for bridging 5, particularly the second clutch part 7. The input 12 is formed by primary part 17 of the first external damper 10. The output 13 of damper configuration 9, in this case is formed by an element of the second damper 11, particularly the secondary part 23 of the second internal damper 11.

The damper configuration 9, viewed in axial direction, is disposed in the power transmission device 1, between device 5 for bridging at least hydrodynamic component 4 partially and hydrodynamic component 4. Preferably, at the same time, due to space reasons, the configuration is selected in an essentially axial plane E. In embodiment according to the state of the art, this causes the limit of the possibility of designing the damper 11 acting as a predamper stage, particularly regarding the damper assembly during installation.

According to the invention, the dampers forming the damper stages are therefore designed and formed in order to be respectively preassembled as a unit and be connected with one another via the means 16 for coupling in radial and in circumferential directions, wherein the second internal damper 11 after the assembly of the first external damper 10 in the power transmission device 1 has to be inserted into the same. The two dampers 10 and 11 of the damper configuration 9 are prefabricated as separately mounted assembly units outside the power transmission device 1 and only joined together in the power transmission device 1 to form a functional unit as damper configuration 9, wherein damper 16 forming the main damper stage is fitted first and mounted and subsequently damper 11 forming the predamper stage, which is disposed internally in radial direction and in the area participating in the connection, owing to the means of connection, is characterized by an outside diameter d_{A11} larger than the internal diameter dᵢ₁₀ of the first damper 10, fitted in axial direction. In addition, an interface 14 is formed in radial direction between both dampers 10, 11, said interface is formed in circumferential direction about the rotation axis R of power transmission device 1 and is characterized by the configuration of the means 16 of connection between both dampers 11 and 10. The coupling of damper 10, 11 is at least realized in circumferential and in radial direction, i.e. at least a rotationally rigid connection is established between both dampers 10, 11.

Viewed in axial section, the interface runs as a line either parallel to the rotation axis R or oblique in the direction of hydrodynamic component 4, i.e. the connection diameter is either constant or reduces in the insertion direction. The connection area can then lie on different diameters or on a conically formed diameter.

Individual assembly diameters for individual elements are depicted here, particularly the internal diameter di5 of device 5 for bridging the external diameter of predamper d_{A11}, the internal diameter of predamper 11 dᵢ₁₁ acting as predamper stage as well as the diameter of turbine hub 15, which is designated here with d₁₅. Furthermore, diameter dₖ₁₀ of first damper 10 on the linkage side of clutch device 5 is depicted. The turbine-wheel side diameter dₜ₁₀ can be selected arbitrarily, however, is generally oriented towards the design of turbine wheel hub 42. The diameter di5, dₖ₁₀ are greater than the diameter d_{A11}.

The second damper 11 is likewise executed as a separately preassembled unit and additionally connected with the hub 3 forming the output A or in a rotationally rigid manner connected with said hub 3. For assembly purposes, a unit consisting of damper 11 and hub 3 forming the predamper stage is preferably inserted as a preassembled unit 43. The function in damper configuration 9 is realized by coupling between the two dampers 10 and 11. At the same time are the means 16 provided for coupling between damper 10 forming the main damper stage and damper 11 forming the predamper stage. These means 16 can be force-closed or form-closed in design. Preferably, a form-closed connection is chosen, through which a connection between the two damper stages is established in radial direction. The individual dampers 10 and 11 can be different in design. In the embodiment depicted in FIG. 1 the overall configuration 9 is formed as a series-connected damper. The individual dampers 10 and 11 are formed as individual dampers, which, in a certain manner, are coupled functionally with one another via the means 16. Damper 10 comprises a primary part 17 acting as input part considered in power flow direction from input to the output and an output part in form of a secondary part 18 connected with one another via the means of torque transmission 19 and means of damping coupling 20, wherein torque transmission and damping coupling is realized via the same elements, here in form of spring units. The two parts—primary part 17 and secondary part 18—are limitedly rotatable relative to one another in circumferential direction and coupled with one another via the means of torque transmission 19, which are provided as spring units 21. This applies analogously also to the second damper 11. This also comprises an input part acting as primary part 22 in the power flow direction, from the input E to the output A, a secondary part 23 acting as output part, coupled with one another by means of torque transmission 24 and means 25 for damping coupling. Here also are the means of torque transmission 24 and the means 25 of damping coupling are formed by the same elements, preferably in form of spring units 26, so that functional concentration occurs.

In the depicted embodiment, primary part 17 of damper 10 is coupled respectively in a rotationally rigid manner with second clutch part 7 of device 5 for at least indirect bridging of hydrodynamic component 4 and hydrodynamic component 4. The output part in form of secondary part 18 is connected in a rotationally rigid manner with second damper unit 11 acting as a predamper stage. At the same time, coupling is established with input and thus with primary part 22. The output part in form of secondary part 23 of the second internal damper 11 is connected in a rotationally rigid manner with hub 3.

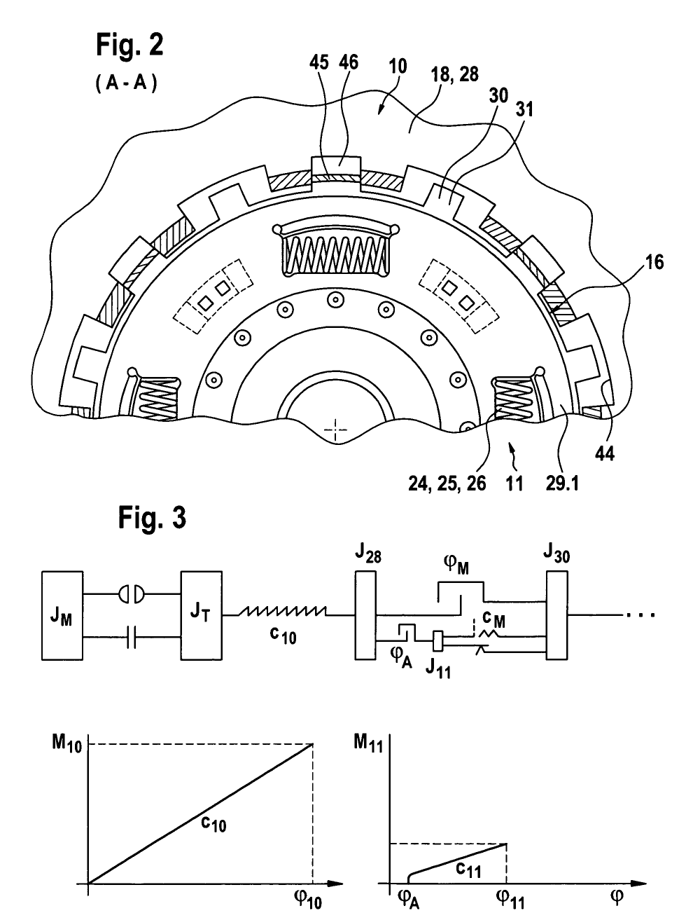

In the depicted case, primary part 17 of the first damper 10 is formed by at least two clutch discs 27.1 and 27.2 disposed connected in parallel to one another; the secondary part 18 of flange 28, viewed in axial direction, is disposed between the two clutch discs 27.1 and 27.2. The two clutch discs 27.1 and 27.2 are at the same time coupled with one another in a rotationally rigid manner. Analogously the primary part 22 of the second damper 11 is likewise formed by two clutch discs 29.1 and 29.2, whereas the secondary part 23 is formed by a flange 30. Here, also are the two clutch discs 29.1 and 29.2 connected with one another in a rotationally rigid manner. The coupling between the two dampers 10 and 11 is via the coupling of the secondary part 18 and thus of the flange 28 of the first damper 10 with primary part 22 and thus the two clutch discs 29.1 and 29.2 of the second damper 11. This is realized via a form-closed connection in form of projections 45 on primary part 22 aligned in both radial and axial directions, particularly clutch discs 29.1 and 29.2, and corresponding with recesses 46, formed on secondary part 18, in form of flange 28 on the first damper 10, suitable for receiving the projections 45. This is exemplarily reproduced using a Section A-A based on FIG. 1 in FIG. 2. Apparent in this illustration are the means 16 for coupling between two dampers 10 and 11, which in this case are implemented quasi as plug-and-socket connectors, wherein the plugging direction is parallel to rotation axis R and thus corresponds to axial direction.

Furthermore, FIG. 1 clarifies a particularly advantageous embodiment of means 16 for coupling the two dampers 10 and 11 with one another and in detail based on a section from a view from the right in accordance with FIG. 1 in FIG. 2, wherein in the course of functional concentration this further features a deflection angle limit 32 for the secondary part 23 of the second damper 11, which simultaneously forms the output part 13 of the damper configuration 9. This is realized via projections 31 aligned in radial direction on the flange 30 of the second damper 11, which engage with the recesses 44 accordingly embodied on the flange 28 in the form of the secondary part 18 of the first damper 10, wherein the cutouts 44 on the flange 28 viewed in circumferential direction are larger than the extension of the projections 31 on the flange 30 in circumferential direction. By this means, the limit stop function is additionally realized here, particularly created via the side surfaces of the receiving recesses 44 and torsional clearance between first damper 10 and second damper 11 or rather secondary part 18 in form of flange 28 and thus limitedly allow rotationally rigid coupling in circumferential direction with this primary part 22 of the second damper 11. The rotationally rigid coupling is realized via projections 45 on the primary part 22 of the second damper 11, which engage with complementary recesses 46 on the secondary part 18, particularly the flange 28 of the first damper 10.

In the embodiment depicted in FIG. 1, it is further apparent that the link of primary part 17 of first damper 10 is optimally based on mounting space conditions. At the same time, the link on top in the radial internal extension device 5 is for bridging. The link of primary part on turbine wheel is as far as possible in the area of hub 3. This occurs preferably via a turbine wheel hub that is mounted on hub 3 in rotatable manner. The installation of first damper 10 can therefore take place separately. Preferably, fastening is done by riveting, wherein in this case both extruded rivets may be used as well as rivets. Fastening elements for coupling with the device for bridging are characterized with 33 in FIG. 1 and characterized with 34 for coupling with hydrodynamic component 4. Analogously, also the second damper 11 is coupled with hub 3. Hence, this fastening is done via fastening means 35, preferably in form of riveting. Here, also, either extruded riveting or separate rivets can be involved. Concerning concrete embodiment of the link there are no restrictions. What is decisive is only that here the mounting space in radial direction is at disposal for axial insertion of the second damper, so that the second damper, with its dimensions in radial direction, particularly the maximum dimensions in radial direction, is smaller than the internal diameter of the device for bridging or rather the link to primary part 17 of first damper 10.

FIG. 3 clarifies the design of the apparatus for damping vibrations, in a schematized and simplified illustration, particularly the damper configuration 9. Individual masses are depicted here. At the same time, the inertial masses are depicted and the clutch between them. J_{M} is the inertial mass of the engine, J_{T} the inertial mass of the turbine wheel, J₂₈ is the inertial mass of flange 28 of the main damper and thus of damper 10, J₃₀ is the inertial mass of hub flange 30. The inertial masses of turbine wheel T and flange 28 are coupled via main damper 10. This applies further also to the engine. The spring constant is designated with c10. Predamper stage 11 is interposed between flange 28 of main damper 10 and inertial mass of hub 3.

In FIG. 3, the torque/deflection angle characteristic curves M/φ are further reproduced for the illustrated system. The characteristic curve of damper 10 and the effective deflection angles φ of predamper 11 are visible in the second diagram.

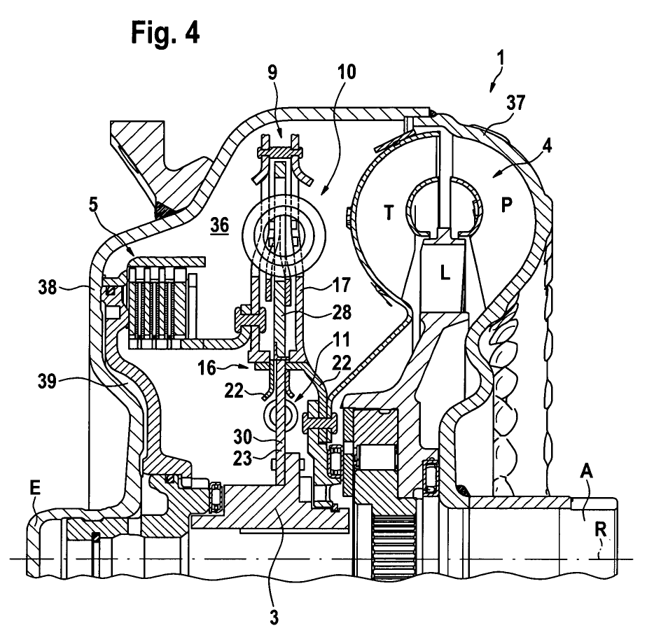

FIG. 4 clarifies a further embodiment of the invention of a damper configuration in a power transmission device 1, where the damper configuration is performed as parallel-connected dampers. In this embodiment contrary to the embodiment of FIG. 1, primary parts 17, 22 of both dampers 10 and 11 are coupled with one another. Coupling is achieved respectively by the means 16 for coupling that are preferably formed as a plug-and-socket connector. Furthermore, also flanges 28, 30 are coupled with one another so that a parallel-connected damping structure is obtained, wherein these become effective in different lengths and deflection angles φ. At the same time, the main damper is dimensioned such that it becomes effective at a certain deflection angle φ only—though not depicted here—the individual recesses on the clutch discs are formed in such a manner that they only become effective after reaching a limit deflection angle, after which internal damper 11 blocks.

The solution according to the invention is not limited to the embodiments depicted in the figures. The figures are only exemplary, wherein FIG. 1 depicts a particularly advantageous embodiment. At the same time the individual damper 10 and 11 are executed as individual dampers. It is also, however, considerable for dampers 10, 11 here, which are characterized by dampers stages respectively with at least two identical or different diameters and formed as series-connected or parallel-connected dampers. It is decisive that individual dampers are preassembled as a unit for installation and coupling to the entire damper configuration 9 only occurs via the means 16.

The embodiment depicted in FIGS. 1 and 4 is known as the so-called three-channel converter version. This means that the power transmission device 1 is characterized by at least three connections, a first connection that is coupled with the working space AR of hydrodynamic component 4, a second connection that is connected with internal space 36 of the power transmission device, which is of an impeller 37 connected with the primary wheel and is formed with an element coupled with the input in the form of cover 38. The third connection III is assigned to a chamber 39 that can be exposed to pressure-tight and liquid-tight pressure means relative to internal space 36. This is limited by actuator 8, particularly the actuation device in the form of piston element 40 and internal circumference 41 of cover 38 as well as of the first clutch part coupled with this in a rotationally rigid manner. The piston 40 guide is provided at the same time with a shaft coupled with the input E.

Other embodiments are considerable. In particular, the power transmission device can also be executed as a two-channel version, in which the device for bridging is not controllable by means of separate pressure, but via the pressure ratio in the internal space and in the working space AR of hydrodynamic component.

### REFERENCE LIST

1 power transmission device
2 transmission input shaft
3 hub
4 hydrodynamic component
5 device for bridging
6 first clutch part
7 second clutch part
8 actuator
9 damper configuration
10 damper
11 damper
12 input part
13 output part
14 output part
15 turbine hub
16 means of coupling
17 primary part
18 secondary part
19 means of torque transmission
20 means of damping coupling
21 spring unit
22 primary part
23 secondary part
24 means of torque transmission
25 means of damping coupling
26 spring unit
27.1, 27.2 drive plate
28 flange
29.1, 29.2 drive plate
30 flange
31 projection
32 deflection angle limit
33 fastening element
34 fastening element
35 fastening element
36 interior space
37 impeller shell
38 cover
39 chamber
40 piston
41 internal circumference
42 turbine wheel hub
43 unit
44 recess
45 projection
46 recess
d₁₅ internal diameter
d_{A11} external diameter
dᵢ₁₁ internal diameter
dₜ₁₀ turbine wheel-side diameter
dₖ₁₀ clutch-side diameter
dᵢ₁₀ internal diameter
d₁₅ diameter of turbine hub
P impeller
T turbine wheel
AR working space
E input
A output
R rotation axis
C₁₀ spring constant
J_{M} inertial mass engine
J_{T} inertial mass turbine wheel
J₁₁ inertial mass predamper
J₂₈ inertial mass flange 28
J₃₀ inertial mass flange 30
L stator
I hydrodynamic power branch
II second power branch
III third connection
φ deflection angle
M/φ torque/deflection angle characteristic curve

What we claim is:

1. A power transmission device for configuration in a drive train between a prime mover and a power take-off with an input coupled with either an output or a hub element forming the output and damper configuration connected upstream of the output, comprising:
at least two dampers coupled with one another and disposed, offset relative to one another in a radial direction, the at least two dampers including a first radial external damper forming a main damper stage and a second internal damper, wherein the second internal damper is coupled with the hub element, the at least two dampers forming individual damper stages made and formed to be preassembled respectively as an assembly unit and coupled with one another at least in a circumferential direction, wherein the second internal damper is insertable into the first external damper.

2. The power transmission device as recited in claim 1 wherein the hub element is preassembled with the second internal damper as a unit.

3. The power transmission device as recited in of claim 1 wherein the dampers are coupled by a form-closed connector.

4. The power transmission device as recited in claim 3 wherein the dampers are coupled by an axial plug and socket connector with respect to a plug-in direction.

5. The power transmission device as recited in claim 1 wherein the dampers are coupled by a force-fit connector.

6. The power transmission device as recited in claim 1 wherein the dampers are coupled with a coupling.

7. The power transmission device as recited in claim 1 wherein the second internal damper has a deflection angle limit for connection.

8. The power transmission device as recited in claim 1 wherein the first and second dampers, viewed in an axial direction, are interposed in an axial plane between the input and the output.

9. The power transmission device as recited in claim 1 wherein the first and second dampers are disposed planes, offset in an axial direction.

10. The power transmission device as recited in claim 1 further comprising a hydrodynamic component and a device for at least partly bridging the power flow via the hydrodynamic component and the damper configuration being disposed in an axial direction between the device for at least partially bridging the power transmission via hydrodynamic component and the hydrodynamic component.

11. The power transmission device as recited in claim 10 wherein a maximum extension of the second internal damper is smaller in the radial direction than a smallest internal diameter of the device for at least partial bridging.

12. The power transmission device as recited in claim 11 wherein the device for at least partial bridging is a switchable clutch device, the switchable clutch device including a first and a second clutch part that can be brought together in an active connection with one another executed at least indirectly via an actuator, the maximum extension of the second internal damper being smaller in the radial direction than an internal circumference of the second clutch part.

13. The power transmission device as recited in claim 10 wherein a part of the first damper is disposed on a side of the device for bridging, the internal diameter of the device for bridging being greater than the maximum extension of the second internal damper in the radial direction.

14. The power transmission device as recited in claim 1 wherein the individual damper stages are respectively configured as dampers connected in a series or in parallel.

15. The power transmission device as recited in claim 1 wherein the first and second dampers are individual dampers.

16. The power transmission device as recited in claim 1 wherein the entire damper configuration is of parallel-connected dampers.

17. The power transmission device as recited in claim 1 wherein the external damper includes at least a primary part and a secondary part being coupled with one another for torque transmission and for damping coupling, the primary and secondary part being limitedly rotatable relative to one another in the circumferential direction.

18. A method of assembly of a damper configuration, comprising:
coupling and disposing at least two dampers with one another, offset in a radial direction relative to one another, the at least two dampers including a first radially external damper forming a main damper stage and a second radially internal damper—in a power transmission device for the configuration in a drive train between a prime mover and a power take-off with an input, coupled with an output or hub element forming the output connected upstream of the damper configuration, wherein the second internal damper is coupled with the hub element, the dampers forming individual damper stages being respectively preassembled as a unit and individually added consecutively in the power transmission device, wherein the first external damper is mounted and respectively connected with connection elements and after a successful connection of the second internal damper inserted in an axial direction parallel-connected to rotation axis R, and the at least two dampers being coupled with one another in the radial direction and in the circumferential direction.

19. The method of assembly of a damper configuration in power transmission device according to claim 18 wherein preassembling the second internal damper with the hub element as a unit and fitting the unit in the power transmission device.
